(19) United States
(12) Patent Application Publication
(10) Pub. No.: US 2026/0141275 A1
(43) Pub. Date: May 21, 2026

(54) SHARED MIXTURE OF EXPERTS

(71) Applicant: International Business Machines Corporation, Armonk, NY (US)

(72) Inventors: UMESH DESHPANDE, San Jose, CA (US); Travis Janssen, San Jose, CA (US); Swaminathan Sundararaman, San Jose, CA (US)

(21) Appl. No.: 18/951,909

(22) Filed: Nov. 19, 2024

(51) Int. Cl. G06N 5/043

(52) U.S. Cl. CPC G06N 5/043

(57) ABSTRACT

A method, computer program product, and computer system for using a shared mixture of experts (MoE) architecture to implement inference with respect to a machine learning model. A gate mechanism receives, from N clients, N requests and an identification of N MoE models. N is at least 2. The gate mechanism selects, from N sets of experts, E experts to process the N requests. The N sets of experts collectively include at least one duplicative expert that is common to more than one set of the N sets of experts. Each duplicative expert has been deduplicated by being stored only once in the one or more graphic processing units (GPUs). The N requests are routed to the E experts. The E experts are executed to generate N respective responses to the N requests. Each response of the N responses is transmitted to the respective client of the N clients.

### BACKGROUND

The present invention relates to a mixture of experts for implementing machine learning inference, and more specifically, to a shared mixture of experts for implementing machine learning inference.

### SUMMARY

Embodiments of the present invention provide a method, a computer program product, and a computer system, for using a shared mixture of experts (MoE) architecture to implement inference with respect to a machine learning model (MLM) that includes model layers.

A gate mechanism comprising N gates receives, from N clients, N requests and an identification of N MoE models, respectively, wherein the N MoE models comprise N sets of experts and N gates, respectively, for each model layer, wherein N is at least 2, wherein the N sets of experts are stored in one or more graphics processing units (GPUs), wherein each expert of the N experts is a machine learning model trained to have expertise in handling specific types of tasks, wherein the N gates are each a machine learning model trained to select experts to process given requests by matching the expertise of each expert to the types of tasks specified in the given requests, wherein the N sets of experts collectively comprise at least one duplicative expert that is common to more than one set of experts of the N sets of experts, and wherein each duplicative expert has been deduplicated by being stored only once in the one or more GPUs.

The gate mechanism selects, from the N sets of experts, E experts to process the N requests, wherein the E experts include the at least one duplicative expert.

The N requests are routed to the E experts.

The E experts are executed to generate N respective responses to the N requests, wherein said executing the E experts comprises each expert of the E experts performing only specific types of tasks that each expert of the E experts has expertise in handling.

Each response of the N responses is transmitted to a respective client of the N clients.

### BRIEF DESCRIPTION OF THE DRAWINGS

FIG. 1 depicts a computing environment which contains an example of an environment for the execution of at least some of the computer code involved in performing the inventive methods, in accordance with embodiments of the present invention.

FIG. 2A depicts a Mixture of Experts (MoE) architecture comprising a first MoE model and a second MoE model for processing requests R1 and R2 from a first client 11 and a second client, respectively, in accordance with embodiments of the present invention.

FIG. 2B depicts a shared Mixture of Experts (MoE) architecture which is a modification of the MoE architecture of FIG. 1 and which includes two gates, in accordance with embodiments of the present invention.

FIG. 2C depicts the shared MoE architecture of FIG. 2B with the two gates being combined into a fused gate with requests R1 and R2 being directed to the fused gate, in accordance with embodiments of the present invention.

FIG. 3 illustrates deduplication of experts, in accordance with embodiments of the present invention.

FIG. 4A depicts sharding an expert to distribute tensors of the expert across multiple GPUs, namely two graphic processing units (GPUs), in accordance with embodiments of the present invention.

FIG. 4B depicts sharding and expert 410 to distribute tensors of expert 410 across multiple GPUs, namely four GPUs, in accordance with embodiments of the present invention.

FIG. 4C depicts sharding of successively accessed experts to distribute their unique tensors across multiple GPUs, combined with deduplication of the tensors, in accordance with embodiments of the present invention.

FIG. 4D depicts sharding of successively accessed experts to distribute their unique tensors in a GPU via deduplication of the tensors, in accordance with embodiments of the present invention.

FIG. 5 is a flow chart of a method for populating experts into GPU memory, in accordance with embodiments of the present invention.

FIG. 6 is a flow chart of a method for using a shared mixture of experts (MoE) architecture to implement inference with respect to a machine learning model (MLM).

FIG. 7 illustrates a computer system, in accordance with embodiments of the present invention.

### DETAILED DESCRIPTION

According to an aspect of the invention, a shared mixture of experts (MoE) architecture is used to implement inference with respect to a machine learning model (MLM) that includes model layers. A gate mechanism comprising N gates receives, from N clients, N requests and an identification of N MoE models, respectively, wherein the N MoE models comprise N sets of experts and N gates, respectively, for each model layer, wherein N is at least 2, wherein the N sets of experts are stored in one or more graphics processing units (GPUs), wherein each expert of the N experts is a machine learning model trained to have expertise in handling specific types of tasks, wherein the N gates are each a machine learning model trained to select experts to process given requests by matching the expertise of each expert to the types of tasks specified in the given requests, wherein the N sets of experts collectively comprise at least one duplicative expert that is common to more than one set of experts of the N sets of experts, and wherein each duplicative expert has been deduplicated by being stored only once in the one or more GPUs. The gate mechanism selects, from the N sets of experts, E experts to process the N requests, wherein the E experts include the at least one duplicative expert. The N requests are routed to the E experts. The E experts are executed to generate N respective responses to the N requests, wherein said executing the E experts comprises each expert of the E experts performing only specific types of tasks that each expert of the E experts has expertise in handling. Each response of the N responses is transmitted to a respective client of the N clients.

The preceding aspect of the invention provides a technical feature of deduplication of experts which advantageously reduces memory consumption by the experts.

According to one embodiment, selecting the E experts includes selecting K top ranked experts from each set of experts of the N sets of experts, wherein K is a positive integer of at least 2, and wherein E < K*N.

The preceding aspect of the invention advantageously selects experts that have the most expertise for handling tasks specified or implied in the requests

According to one embodiment, an identity of each deduplicated expert is mapped to a merged representation that links each deduplicated expert to the requests of different clients, wherein routing the N request to the E experts includes: batching the N requests of the different clients to the deduplicated experts by routing the N requests to the E experts in parallel which avoids sequential invocation of the N gates for routing the N requests to the E experts.

The preceding aspect of the invention provides a technical feature of routing the N requests to the E experts in parallel which advantageously avoids sequential invocation of the N gates for routing the N requests to the E experts.

According to one embodiment, the gate mechanism includes a single fused gate that combines the N gates’ functionalities, wherein the fused gate selects the E experts which are a same E experts that would have been selected by the N gates individually if the N gates were not combined into the fused gate, wherein the fused gate routes the N requests to the E experts in parallel which avoids sequential invocation of the N gates for routing the N requests to the E experts, and wherein the gate mechanism includes a gate mapping for each gate of the N gates.

The preceding aspect of the invention provides a technical feature of using a fused gate for routing the N requests to the E experts in parallel which advantageously avoids sequential invocation of the N gates.

According to one embodiment, executing the E experts comprises: batch executing, by the deduplicated experts, M requests of the N requests by executing the M requests in parallel which is facilitated by multiple streaming multiprocessors (SM's) in the one or more GPUs that comprise the deduplicated experts.

The preceding aspect of the invention provides a technical feature of batch executing M requests of the N requests in parallel which advantageously reduces the computation time for executing the requests.

According to one embodiment, each expert in the N sets of experts comprises multiple tensors, wherein the one or more GPUs is a plurality of GPUs, wherein one expert in the N sets of experts does not fit into any GPU of the plurality of GPUs, and wherein each expert of the one expert has been sharded to distribute the multiple tensors of the one expert across the plurality of GPUs.

The preceding aspect of the invention provides a technical feature of sharding the tensors of an expert across multiple GPUs which advantageously enables a large expert to fit into GPU memory.

According to one embodiment, each expert in the N sets of experts comprises multiple tensors, wherein a first expert and a second expert of the E experts comprises at least one duplicative tensor that is common to the first expert and the second expert, and wherein each duplicative tensor has been deduplicated by being stored only once in the one or more GPUs.

The preceding aspect of the invention provides a technical feature of sharding deduplicated tensors of multiple experts which advantageously reduces memory consumption by the deduplicated tensors.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

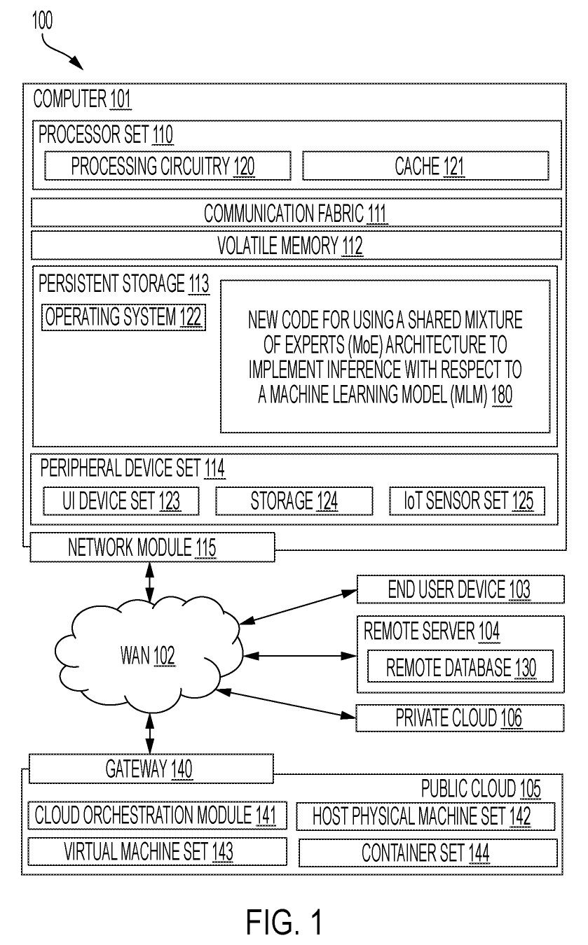

FIG. 1 depicts a computing environment 100 which contains an example of an environment for the execution of at least some of the computer code involved in performing the inventive methods, in accordance with embodiments of the present invention. Such computer code includes new code for using a shared mixture of experts (MoE) architecture to implement inference with respect to a machine learning model (MLM) 180. In addition to block 180, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 180, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 180 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input / output ports and the like. Other types of signal communication paths may be used, such as fiber optic communication paths and/or wireless communication paths

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 180 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider’s systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

Embodiments of the present invention are directed to using a shared mixture of experts (MoE) to implement inference with respect to a machine leaning model. An example of a machine learning model is a large language model (LLM). Although embodiments of the present invention are described herein for an LLM, such embodiments are not limited to an LLM and are generally applicable to any machine learning model.

A large language model (LLM) is a type of machine learning model that is typically trained on immense amounts of data making the LLM capable of understanding and generating natural language and other types of content to perform a wide range of tasks.

The LLM may encompass a Mixture of Experts (MoE) model that includes a plurality of experts and an associated gate. An expert in each MOE model is software that specializes in handling a specific task. A gate is software that is trained to select experts to perform respective tasks specified or implied by a request received from a client. This specialization by the experts of the MoE model allows the MoE model to allocate computational resources more efficiently, as each expert can focus on particular characteristics of the input data.

Each expert in an MoE model typically includes one or more tensors that store the parameters (e.g., weights and biases) associated with that expert’s sub-network. These tensors are generated during training of an expert so that the expert becomes skilled in performing specific tasks or processing specific subject matter.

During inference, which performs the tasks required by the request received from the client, the gate (e.g., a small neural network) selects a subset of the experts of an MoE based on the relevance of the experts to the tasks specified or implied in the request, which conserves computational resources.

The modular structure of the MoE architecture allows users to compose their MoE model from popular off-the-shelf experts, which may result in multiple MoE deployments with identical experts. Duplication of identical experts across MoE model instances results in excessive graphic processing unit (GPU) memory consumption and increased model serving costs. In addition, since all experts are not invoked for each request, individual experts rarely receive enough requests to exploit the GPUs’ computing capacity which results in low GPU utilization.

Embodiments of the present invention resolve the proceeding problems by using a shared MoE architecture that shares experts across MoE model instances and automatically identifies and deduplicates identical experts across the MoE model instances, thus reducing the overall memory footprint. The shared MoE architecture batches the requests directly toward the identical experts belonging to different clients, which also improves the processing efficiency and model throughput.

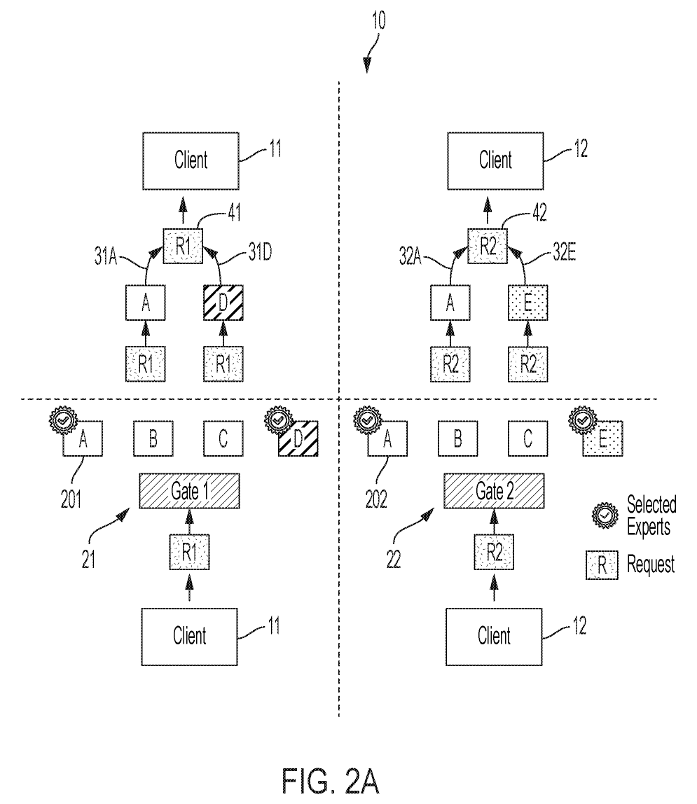

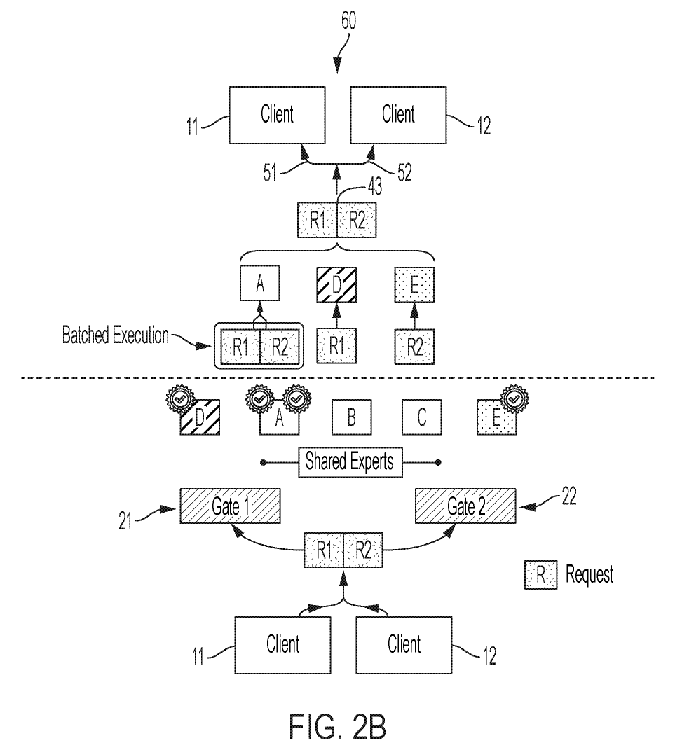

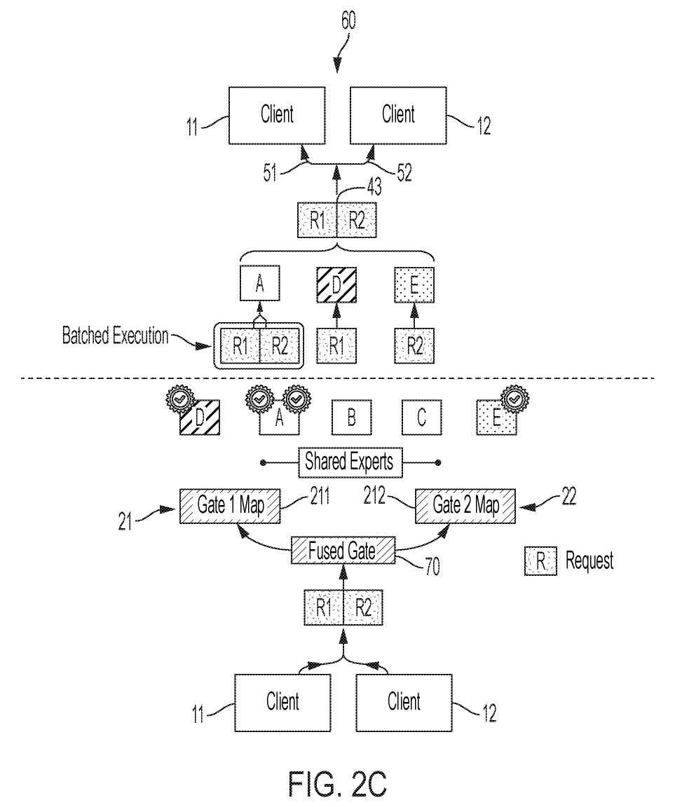

FIG. 2A depicts a Mixture of Experts (MoE) architecture 10 comprising MoE model 21 and MoE model 22 for processing requests R1 and R2 from a client 11 and a client 12, respectively, in accordance with embodiments of the present invention.

FIG. 2A depicts, for client 11, a first process that is performed for each model layer of a machine learning model, wherein the first process begins with Gate 1 receiving request R1 and ends with generation of combined output 41. Similarly, FIG. 2A depicts, for client 12, a second process that is performed for each model layer of the machine learning model, wherein the second process begins with Gate 32 receiving request R2 and ends with generation of combined output 42.

The MoE model 21 includes experts A, B, C, and D and Gate 1 for each model layer, and the MoE model 22 includes experts A, B, C, and E and Gate 2 for each model layer. Experts A, B and C can be shared for processing requests, and experts D and E are dedicated experts specific for MoE model 21 and MoE model 22, respectively, and cannot be shared.

The client 11 submits request R1 and has selected MoE 21 to process the request R1, and the client 12 submits request R2 and has selected MoE 22 to process the request R2.

Gate 1 selects experts A and D to process request R1, and Gate 2 selects experts A and E to process request R2.

A first instance 201 of expert A processes one or more specialized tasks in request R1 and a second instance 202 of expert A processes one or more specialized tasks in request R2. The first instance 201 and the second instance 202 of expert A are each stored in different graphic processing unit (GPU) memory locations. Thus, expert A is not being shared for processing requests R1 and R2. Unfortunately, the duplication of expert A across MoE models 21 and 22 results in excessive GPU memory consumption and increased MoE model serving cost.

Expert D processes specialized tasks in request R1 and expert E processes specialized tasks in request R2.

Combined output 41 includes a combination of: (i) output 31A from the processing by expert A of one or more specialized tasks specified in request R1 and (ii) output 31D from the processing by expert D of one or more specialized tasks specified in request R1. The combined output 41 is transmitted to client 11 in response to the request R1.

Combined output 42 includes a combination of: (i) output 32A from the processing by expert A of one or more specialized tasks specified in request R2 and (ii) output 32E from the processing by expert E of one or more specialized tasks specified in request R2. The combined output 42 is transmitted to client 12 in response to the request R2.

FIG. 2B depicts a shared Mixture of Experts (MoE) architecture 60 which is a modification of the MoE architecture 10 of FIG. 1, in accordance with embodiments of the present invention.

FIG. 2B depicts a process that is performed for each model layer of the machine learning model, wherein the process begins with Gate 1 and Gate 2 receiving request R1 and request R2, respectively, and ends with generation of combined output 43.

As in the MoE architecture 10 in FIG. 2A, the MoE model 21 includes experts A, B, C, and D and Gate 1 for each model layer, and the MoE model 22 includes experts A, B, C, and E and Gate 2 for each model layer. Experts A, B and C can be shared, and experts D and E are dedicated experts specific for MoE model 21 and MoE model 22, respectively, and cannot be shared.

Unlike the MoE architecture 10 in FIG. 2A in which expert A is not shared for processing requests R1 and R2, expert A in the architecture 60 in FIG. 2B is shared for processing requests R1 and R2 by having expert A occupy only one area of GPU memory, which reduces GPU memory consumption by the experts and which is accomplished by a process of deduplication described infra in conjunction with FIG. 2.

A duplicative expert is defined as an expert that is common to more than one set of experts of multiple sets of experts. Thus, expert A is a duplicative expert, because expert is common to (i.e., included in) the set of experts consisting of the MoE model 21 and the set of experts consisting of the MoE model 22.

The shared MoE architecture 60 also batches a routing of requests R1 and R2 to the experts D, A and E by routing requests R1 and R2 in parallel to the experts D, A and E, which results in higher throughput.

One stored instance of expert A in a GPU processes one or more specialized tasks in request R1 and one or more specialized tasks in request R2. Expert D processes one or more specialized tasks in request R1 and expert E processes one or more specialized tasks in request R2.

The requests R1 and R2 are batch executed by the deduplicated expert A that is stored in the GPU by having requests R1 and R2 executed in parallel which is facilitated by multiple streaming multiprocessors (SM's) in the GPU that stores the deduplicated expert A.

Combined output 43 includes a combination of: (i) output from the processing by one instance of expert A of one or more specialized tasks specified in request R1 and one or more specialized tasks specified in request R2, (ii) output from the processing by expert D of one or more specialized tasks specified in request R1, and (iii) output from the processing by expert E of one or more specialized tasks specified in request R2.

The combined output 43 is separated into (i) an output component 51 which is responsive to request R1 and is transmitted to client 11 and (ii) an output component 52 which is responsive to request R2 and is transmitted to client 12.

FIG. 2C depicts the shared MoE architecture 60 of FIG. 2B with Gate 1 and Gate 2 being combined into a fused gate 70 with requests R1 and R2 being directed to the fused gate 70, in accordance with embodiments of the present invention.

FIG. 2C depicts a process that is performed for each model layer of the machine learning model, wherein the process begins with the fused gate 70 receiving request R1 and request R2 and ends with generation of combined output 43.

With Gate 1 and Gate 2 being combined into the single fused gate 70 for each model layer, a combined routing routes the multiple routing requests R1 and R2 which are processed in a batch. The combined routing efficiently executes requests R1 and R2 in parallel with little impact on the routing latency. With the fused gate 70, there is a gate mapping 211 for MoE model 21 and a gate mapping 212 for MoE model 22, so the output of the fused gate 70 can correctly select the same experts as the experts that would have been selected by Gate 1 and Gate 2 before being combined into the fused gate 70.

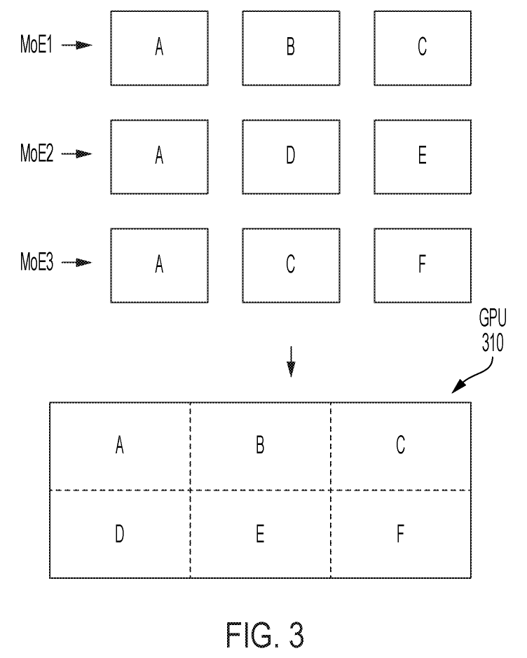

FIG. 3 illustrates deduplication of experts, in accordance with embodiments of the present invention. In one embodiment, the deduplication of experts is performed prior to inference.

In FIG. 3, MoE models MoE1, MoE2 and MoE3 are loaded into memory GPU 300 in succession. MoE model MoE1 consists of experts A, B and C. MoE model MoE2 consists of experts A, D and E. MoE model MoE3 consists of experts A, C and F.

Expert A appears in MoE models MoE1, MoE2 and MoE3, but only one instance of expert A is stored in memory GPU 310.

Expert C appears in MoE models MoE1 and MoE3, but only one instance of expert C is stored in memory GPU 310.

Consequently, although MoE models MoE1, MoE2 and MoE3 collectively consists of 9 experts, only 6 of the 9 experts are stored in memory GPU 310, which reduces memory consumption by the experts in models MoE1, MoE2 and MoE3.

Furthermore, in a scenario in which the 9 experts are collectively too large to fit within GPU 310, the deduplication shown in FIG. 3 enables all of the 6 unique experts in MoE models MoE1, MoE2 and MoE3 to fit within GPU 310, which avoids storing the 9 experts in multiple GPUs.

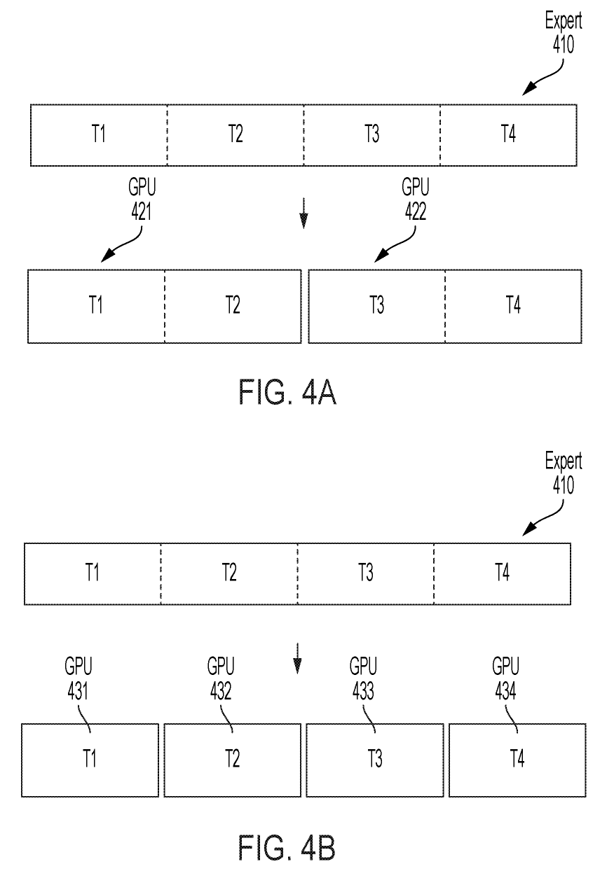

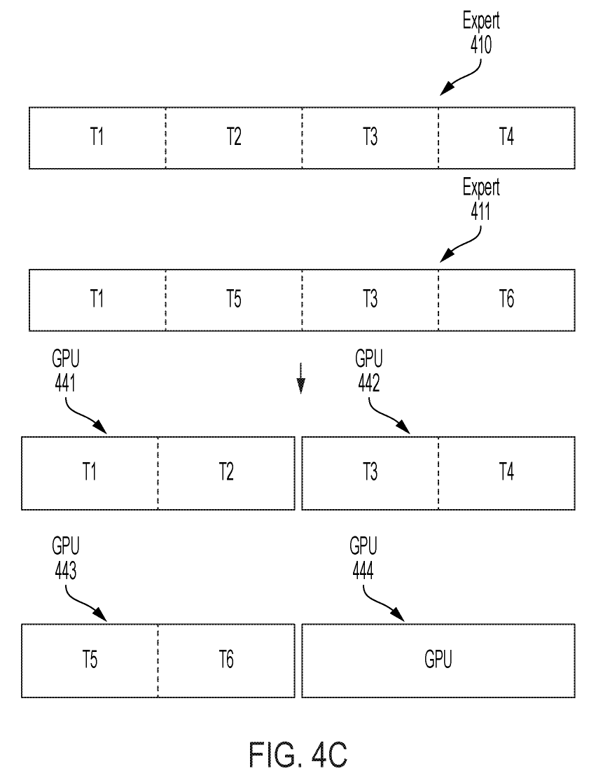

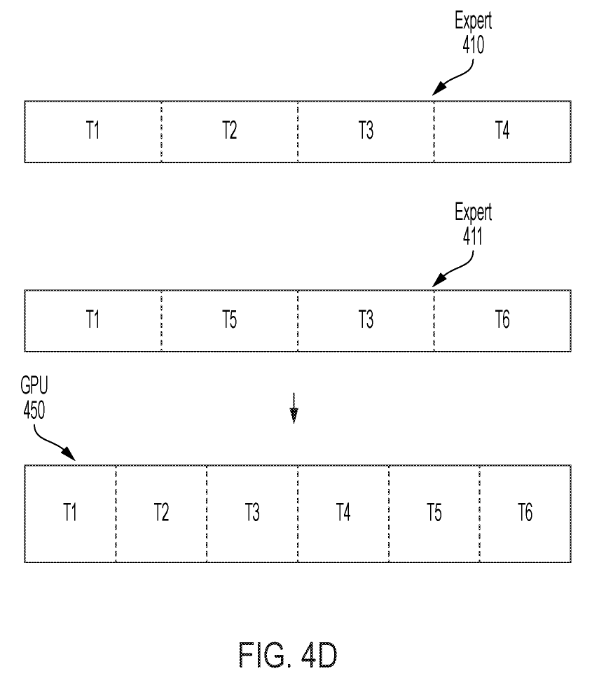

FIG. 4A depicts sharding expert 410 to distribute tensors T1, T2, T3 and T4 of expert 410 across multiple GPUs, namely the two GPUs 421 and 422, in accordance with embodiments of the present invention.

The sharding of expert 410 in FIG. 4A is a tensor parallel deployment motivated by the fact that expert 410 is too large to fit into one GPU and is therefore sharded across two GPUs 421 and 422 into which the four tensors T1, T2, T3 and T4 fit, with tensors T1 and T2 fitting into GPU 421 and tensors T3 and T4 fitting into GPU 422. The two tensors T1 and T2 can be accessed and processed in parallel by respective streaming multiprocessors (SM's) in GPU 421. The two tensors T3 and T4 can be accessed and processed in parallel by respective SMs in GPU 422.

FIG. 4B depicts sharding expert 410 to distribute tensors T1, T2, T3 and T4 of expert 410 across multiple GPUs, namely four GPUs 431, 432, 433, and 434, in accordance with embodiments of the present invention.

The sharding of expert 410 in FIG. 4B is a tensor parallel deployment motivated by the fact that expert 410 is too large to fit into one GPU and is therefore sharded across four GPUs 431, 432, 433, and 434 into which the four tensors T1, T2, T3 and T4 fit.

FIG. 4C depicts sharding of successively accessed experts 410 and 411 to distribute their unique tensors across multiple GPUs 441, 442 and 443, combined with deduplication of the tensors, in accordance with embodiments of the present invention.

Expert 410 comprises four tensors T1, T2, T3 and T4, and expert 411 comprises four tensors T1, T5, T3 and T6.

The sharding of experts 410 and 411 in FIG. 4C is a tensor parallel deployment motivated by the fact that experts 410 and 411 are each too large to fit into one GPU and are therefore sharded across three GPUs 441, 442, and 443 into which the six unique tensors T1, T2, T3, T4, T5 and T6 fit.

The storage of the six unique tensors T1, T2, T3, T4, T5 and T6 across GPUs 441, 442 and 443 is a result of deduplication of tensors T1 and T3 each of which appear twice in the combination of experts 411 and 412. The deduplication of tensors T1 and T3 reduces GPU memory consumption. As a result of the deduplication of tensors T1 and T3, only the three GPUs 441, 442 and 443 are used to store the six tensors T1, T2, T3, T4, T5 and T6. If deduplication of tensors T1 and T3 were not implemented, the four GPS 441, 442, 443 and 444 would be used to store the eight tensors in experts 410 and 411.

FIG. 4D depicts sharding of successively accessed experts 410 and 411 to distribute their unique tensors in GPU 450 via deduplication of the tensors, in accordance with embodiments of the present invention.

Expert 410 comprises four tensors T1, T2, T3 and T4, and expert 411 comprises four tensors T1, T5, T3 and T6. Tensors T1 and T3 appear in both 410 and expert 411.

The unique tensors T1, T2, T3, T4, T5 and T6 in experts 410 and 411 are each stored only one in GPU 450 via deduplication of tensors T1 and T3.

In one embodiment, GPU 450 is large enough to store all 8 tensors of experts 410 and 411, so that the deduplication of tensors T1 and T3 results in extra available storage that can be used in GPU 450 for any useful purpose.

In one embodiment, GPU 350 is not large enough to store all 8 tensors of experts 310 and 311, so that the deduplication of tensors T1 and T3 results in avoiding having to use GPU 350 and another GPU to store all 8 tensors of experts 310 and 311.

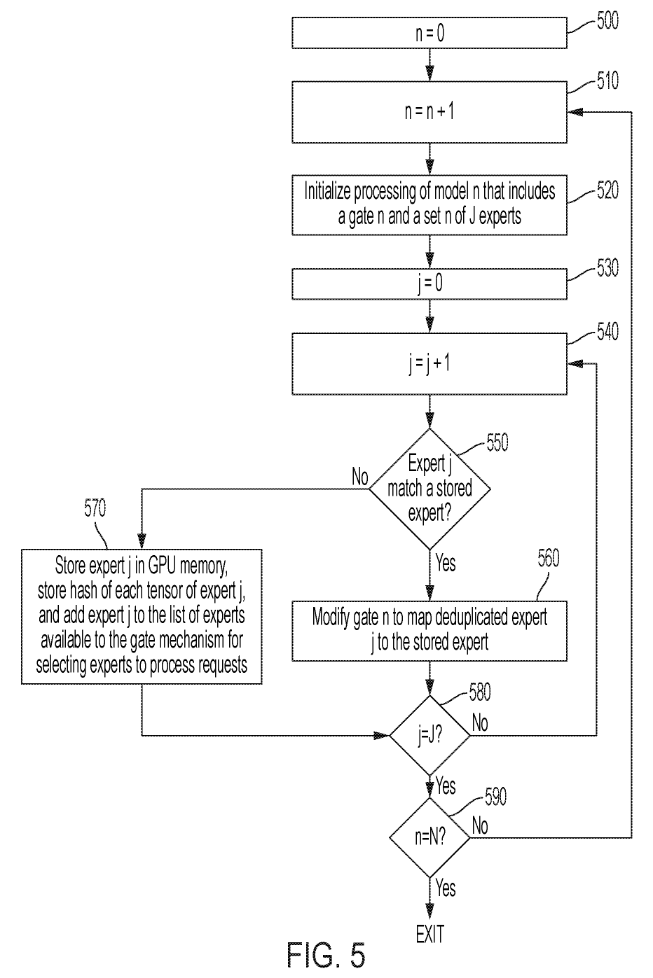

FIG. 5 is a flow chart of a method for populating experts into GPU memory, in accordance with embodiments of the present invention. The flow chart of FIG. 5 includes steps 500-590.

In one embodiment, the method of FIG. 5 is performed prior to inference.

The method of FIG. 5 processes N MoE models wherein N is at least 2, and each expert n includes a gate n and a set n of J experts (n = 1, …, N). In one embodiment, J is constant over n. In one embodiment, J can change as n changes. Each expert includes a plurality of tensors.

Step 500 sets a model index n to zero.

Step 510 increments n by 1.

Step 520 initializes processing of model n that includes gate n and a set n of J experts.

Step 530 sets an expert index j to zero.

Step 540 increments j by 1.

Step 550 determines whether expert j matches (i.e., is identical to) an expert already stored in GPU memory. If so (Yes branch from step 550) then step 560 is next executed, and if not (No branch from step 550) then step 570 is next executed.

Expert j matches a stored expert if every tensor of expert j and every tensor of the stored expert match each other (i.e., are identical to each other) which requires expert j and the stored tensor have a same number of tensors i order to match each other.

In one embodiment, implementation of step 550 comprises comparing the elements of each tensor of expert j with the corresponding elements of each tensor of the stored expert to determine whether the tensors whose elements are being compared match each other.

In one embodiment, implementation of step 550 comprises comparing a hash of each tensor of expert j with a hash of the corresponding tensor of the stored expert to determine whether the tensors whose hashes are being compared match each other. In this embodiment, step 550 computes and stores the hash of each tensor in expert j before the hash of the tensors of expert j are compared with the hash of the tensors in the stored experts.

Step 560 modifies gate n to map deduplicated expert j to the stored expert that expert j matches.

Step duplicative stores expert j in GPU memory and stores a hash of each tensor of expert j in anticipation of needing the hash of each tensor of expert j to perform step 550 subsequently for remaining experts (j+1, …, N). Step 570 also adds expert j to the list of experts from which the gate mechanism selects experts to process requests.

In step 570, expert j can be stored in one or more GPUs of GPU memory in its entirety or partially in accordance with any of the embodiments described supra in conjunction with FIGS. 4A-4D.

Step 580 determines whether j = J. If so (Yes branch from step 580) then step 590 is next executed, and if not (No branch from step 580) then processing loops back to step 540 to process the next expert j+1.

Step 590 determines whether n = N. If so (Yes branch from step 590) then the method of FIG.5 exits, and if not (No branch from step 590) then processing loops back to step 510 to process the next MoE model n+1.

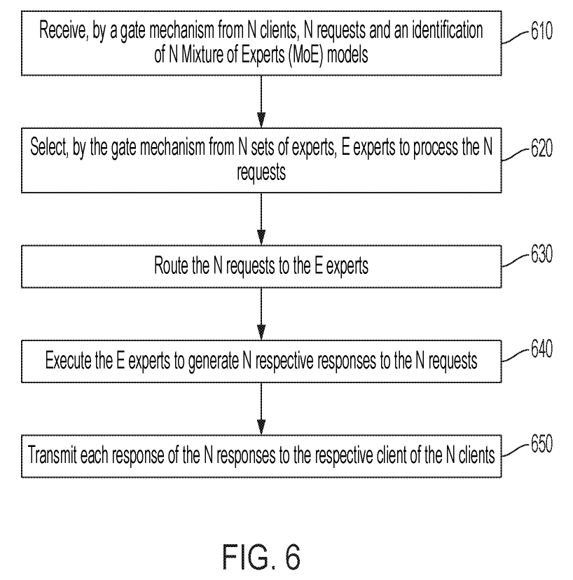

FIG. 6 is a flow chart of a method for using a shared mixture of experts (MoE) architecture to implement inference with respect to a machine learning model (MLM). The method of FIG. 6 includes steps 610-650.

In step 610, a gate mechanism comprising N gates receives, from N clients, N requests and an identification of N MoE models, respectively, wherein N is at least 2.

The N MoE models comprise N sets of experts and N gates, respectively.

The N sets of experts are stored in one or more graphics processing units (GPUs), wherein each expert of the N experts is a machine learning model trained to have expertise in handling specific types of tasks.

The N gates are each a machine learning model trained to select experts to process given requests by matching the expertise of each expert to the types of tasks specified in the given requests.

The N sets of experts collectively comprise at least one duplicative expert that is common to more than one set of experts of the N sets of experts, wherein each expert in the N sets of experts comprises multiple tensors, and wherein each duplicative expert has been deduplicated by being stored only once in the one or more GPUs

Step 620 selects, by the gate mechanism from the N sets of experts, E experts to process the N requests, wherein the E experts include the at least one duplicative expert. E is at least 2.

The gate mechanism has been trained to select experts via each gate of the N gates having been trained to select experts best suited to respond to the tasks specified or implied by the request. Each gate is trained to weight each expert for performing a task in consideration of the expertise of each expert in relation to the task. Thus, each gate is able rank each expert’s capability of performing a task specified or implied by the request.

In one embodiment, the gate mechanism selects E experts by selecting the K top ranked experts from each set of experts of the N sets of experts, wherein K is a positive integer of at least 2, and wherein E < K*N. In one embodiment, K is an inputed constant.

In one embodiment, the gate mechanism comprises a single fused gate that combines the N gates’ functionalities, wherein the fused gate selects the E experts which are a same E experts that would have been selected by the N gates individually if the N gates were not combined into the fused gate, wherein the fused gate routes the N requests to the E experts in parallel which avoids sequential invocation of the N gates for routing the N requests to the E experts, and wherein the gate mechanism includes a gate mapping for each gate of the N gates.

In one embodiment, an identity of each deduplicated expert is mapped to a merged representation that links each deduplicated expert to the requests of different clients.

Step 630 routes the N requests to the E experts.

In one embodiment, routing the N request to the E experts comprises: batching the N requests of the different clients to the deduplicated experts by routing the N requests to the E experts in parallel which avoids sequential invocation of the N gates for routing the N requests to the E experts.

Step 640 executes the E experts to generate N respective responses to the N requests, wherein executing the E experts comprises each expert of the E experts performing only specific types of tasks that each expert of the E experts has expertise in handling.

In one embodiment, executing the E experts comprises: batch executing, by the deduplicated experts, M requests of the N requests by executing the M requests in parallel which is facilitated by multiple streaming multiprocessors (SM's) in the one or more GPUs that comprise the deduplicated experts.

After separating the N responses from each other, step 650 transmits each response of the N responses to the respective client of the N clients.

In one embodiment, each expert in the N sets of experts comprises multiple tensors, wherein the one or more GPUs is a plurality of GPUs, wherein one expert of the T experts does not fit into any GPU of the plurality of GPUs, and wherein each expert of the one expert has been sharded to distribute the multiple tensors of the one expert across the plurality of GPUs.

In one embodiment, each expert in the N sets of experts comprises multiple tensors, wherein first expert and a second expert of the E experts comprises at least one duplicative tensor that is common to the first expert and the second expert, and wherein each duplicative tensor has been deduplicated by being stored only once in the one or more GPUs.

Thus, embodiments of the present invention provide a shared Mixture of Experts model that automatically identifies and deduplicates identical experts across MoE model instances, thus reducing the memory footprint of the MoE. Moreover, embodiments of the present invention using the shared MoE architecture batches the requests directed toward the identical experts belonging to different clients, which also improves the processing efficiency.

With embodiments of the present invention, a single inference service can host several MoE model instances. Embodiments of the present invention identify and deduplicate identical experts across MoE instances. FIG. 1B, described supra, shows a deduplicated expert A across two clients. The sharing of experts is beneficial in the following ways.

First, the sharing of experts reduces the GPU memory requirement for running multiple model instances.

Second, the requests for the deduplicated experts are batched, even if the requests belong to different clients. For example, in FIG. 1B, requests R1 and R2 (directed towards deduplicaterd expert A) belong to two different clients. However, batching execution of requests R1 and R2 toward expert A improves computational efficiency.

Embodiments of the present invention using the shared MoE architecture provides the following contributions.

A first contribution of embodiments of the present invention using the shared MoE architecture is transparent detection of identical experts from across multiple clients and sharing the identical experts during inference. The client need not provide additional hints to enable sharing of experts. Moreover, to support the large experts that cannot fit in the memory of a single GPU, embodiments of the present invention provide tensor-parallel execution of experts. In a tensor-parallel mode, embodiments of the present invention provide deduplicated shards of experts to enable the sharing of experts across multiple GPUs.

A second contribution of embodiments of the present invention using the shared MoE architecture provides techniques for improving the processing efficiency while leveraging model sharing in MoE. Specifically, embodiments of the present invention batch the execution of requests from multiple clients when the requests are to be executed by the deduplicated experts, which improves computational efficiency. Next, the gates of multiple MoE model instances are fused to avoid sequential invocation of gates during inference at each layer. The fused routing of requests further improves the scalability of shared MoE architecture.

A third contribution of embodiments of the present invention using the shared MoE architecture is that additional experts can be added to an existing MoE model. Moreover, embodiments of the present invention allow service providers to dynamically integrate experts and gates used by new clients to already deployed MoE instances.

Embodiments of the present invention handle limited GPU memory by serving MoE models on GPU(s) which have only enough memory to accommodate the MoE models with already deduplicated experts, thus avoiding any pre-allocation of memory.

Embodiments of the present invention enable adding a new MoE model instance to the shared MoE architecture or removing an existing MoE model instance from the shared MoE architecture, without recording a system restore.

Even with a combined representation of MoE models, a client can independently submit requests to the client’s own MoE model instance for which embodiments of the present invention can provide a user interface, and MoE model instances (i.e., experts and gates) can be added to the base MoE model, which can be invoked independently through separate calls but executed simultaneously whenever possible.

All MoE model instances in the shared MoE architecture can provide almost equivalent latency and throughput as with the separately deployed individual MoE models.

Embodiments of the present invention implement memory allocation of experts by performing tensor-level deduplication of identical experts when loading the MoA model from storage. Embodiments of the present invention can calculate 128-bit hash digest of each tensor associated with an expert and store the hash in an in-memory dictionary for later reference. The in-memory dictionary is referred to by the subsequent experts to check if an identical expert was previously loaded. If no identical expert was previously loaded, GPU memory is allocated to the new expert. Otherwise, the new expert refers to the tensors of the previously loaded identical expert.

Without the shared MoE architecture, experts would be pre-allocated to GPU memory at MoE model initialization, which implies that the memory required to accommodate an entire MoE model would need to be available prior to loading the MoE model’s parameters from a model file. Often, GPUs may not have enough memory to accommodate several MoE model instances, even if the memory is later released back to the system after deduplication. To reduce the memory requirement at the model initialization time, embodiments of the present invention initialize the MoE model with tiny pseudo experts. The tiny pseudo experts are later resized and populated by parameters when loading the MoE model from a file. As a result, the shared MoE architecture only uses the amount of GPU memory with deduplicated experts (ignoring the minor increase in memory consumption from the current expert, which remains in memory until its deduplication).

Embodiments of the present invention provide an independent representation for each expert individually in the MoE model structure, so that each expert’s memory can be managed independently from the memory of the other experts.

MoE models may include large experts, where each large expert consumes several gigabytes of GPU memory. As a reference point, in Mixtral-8x7B each expert requires 14GB of GPU memory. Such large models rarely fit on a single GPU. To address this problem, embodiments of the present invention shard experts across the available GPUs, which evenly distributes the request load and avoids imbalance. In addition, embodiments of the present invention add tensor-parallel loading of new experts to an already hosted MoE model. Upon loading the initial MoE parameters, the new experts mimic the sharding from the initial MoE model. For example, if the initial MoE’s experts were sharded 4-ways across 4 GPUs, the subsequent new experts are also sharded 4-ways. In addition, embodiments of the present invention deduplicate the expert shards in the same fashion as the entire experts.

To enable dynamic addition of an MoE model instance, embodiments of the present invention implement a seamless integration mechanism, where a new MoE model instance can add its experts and gates into the existing shared MoE architecture and perform deduplication of the new experts. Similarly, any existing MoE model instance can be removed non-disruptively. However, MoE model instances cannot be added or removed while the MoE model is actively serving inference requests, because of the temporarily undefined MoE structure during integration of the added or removed MoE model instances.

During inference, embodiments of the present invention batch the requests from multiple clients directed toward different MoE model instances and propagate each client's model ID along with the request through the execution of all MoE layers so that the routing mechanism can select the correct gate(s).

Embodiments of the present invention implement a fused gate which combines the original gates into a single fused gate to efficiently execute multiple routing requests in parallel in a batch. The combined routing efficiently executes several requests in parallel with little impact on the routing latency. With a fused gate, embodiments of the present invention maintain a gate mapping for each MoE model instance, so the output of the fused gate can be correctly interpreted to select the same experts as the original gates.

To deduplicate experts, embodiments of the present invention assign unique identity to each expert in MoE model architecture. To batch requests and thus avoid the separate processing of requests, embodiments of the present invention create a merged representation of identical experts after model initialization. When processing an inference request, each MoE’s gate maps the identity of the expert to its new merged representation. As a result of the merged representation, the requests towards the deduplicated experts are batched for processing even if the deduplicated experts belong to different clients. Thus, due to use of the high-performance parallel architecture of GPUs, embodiments of the present invention can process large batches of requests with increased efficiently.

In one embodiment, the shared MoE architecture is hosted by a service provider, so that clients only need to submit their models for serving and the clients do not have access to the infrastructure hosting the MoE models. Therefore, a client cannot read other clients’ data (e.g., requests or activations) or MoE model parameters. In this embodiment, an application programming interface (API) may be employed to receive a request from a client and send the request to the MoE model specified by the client.

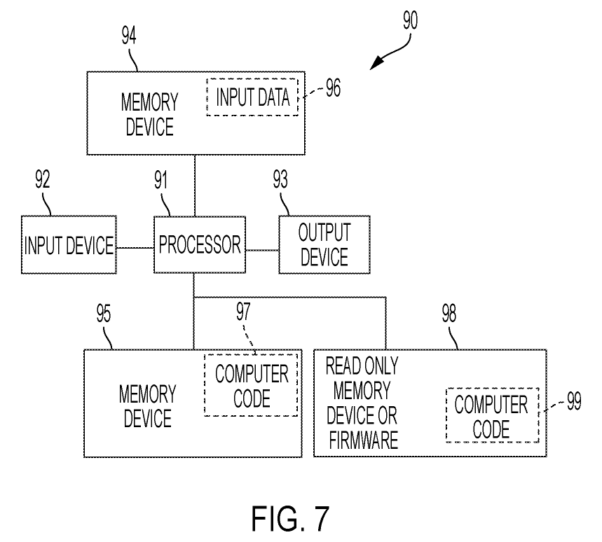

FIG. 7 illustrates a computer system 90, in accordance with embodiments of the present invention.

The computer system 90 includes a processor 91, an input device 92 coupled to the processor 91, an output device 93 coupled to the processor 91, and memory devices 94 and 95 each coupled to the processor 91. The processor 91 represents one or more processors and may denote a single processor or a plurality of processors. The input device 92 may be, inter alia, a keyboard, a mouse, a camera, a touchscreen, etc., or a combination thereof. The output device 93 may be, inter alia, a printer, a plotter, a computer screen, a magnetic tape, a removable hard disk, a floppy disk, etc., or a combination thereof. The memory devices 94 and 95 may each be, inter alia, a hard disk, a floppy disk, a magnetic tape, an optical storage such as a compact disc (CD) or a digital video disc (DVD), a dynamic random access memory (DRAM), a read-only memory (ROM), etc., or a combination thereof. The memory device 95 includes a computer code 97. The computer code 97 includes algorithms for executing embodiments of the present invention. The processor 91 executes the computer code 97. The memory device 94 includes input data 96. The input data 96 includes input required by the computer code 97. The output device 93 displays output from the computer code 97. Either or both memory devices 94 and 95 (or one or more additional memory devices such as read only memory device 96) may include algorithms and may be used as a computer usable medium (or a computer readable medium or a program storage device) having a computer readable program code embodied therein and/or having other data stored therein, wherein the computer readable program code includes the computer code 97. Generally, a computer program product (or, alternatively, an article of manufacture) of the computer system 90 may include the computer usable medium (or the program storage device).

In some embodiments, rather than being stored and accessed from a hard drive, optical disc or other writeable, rewriteable, or removable hardware memory device 95, stored computer program code 99 (e.g., including algorithms) may be stored on a static, nonremovable, read-only storage medium such as a Read-Only Memory (ROM) device 98, or may be accessed by processor 91 directly from such a static, nonremovable, read-only medium 98. Similarly, in some embodiments, stored computer program code 99 may be stored as computer-readable firmware, or may be accessed by processor 91 directly from such firmware, rather than from a more dynamic or removable hardware data-storage device 95, such as a hard drive or optical disc.

Still yet, any of the components of the present invention could be created, integrated, hosted, maintained, deployed, managed, serviced, etc. by a service supplier who offers to improve software technology associated with cross-referencing metrics associated with plug-in components, generating software code modules, and enabling operational functionality of target cloud components. Thus, the present invention discloses a process for deploying, creating, integrating, hosting, maintaining, and/or integrating computing infrastructure, including integrating computer-readable code into the computer system 90, wherein the code in combination with the computer system 90 is capable of performing a method for enabling a process for improving software technology associated with cross-referencing metrics associated with plug-in components, generating software code modules, and enabling operational functionality of target cloud components. In another embodiment, the invention provides a business method that performs the process steps of the invention on a subscription, advertising, and/or fee basis. That is, a service supplier, such as a Solution Integrator, could offer to enable a process for improving software technology associated with cross-referencing metrics associated with plug-in components, generating software code modules, and enabling operational functionality of target cloud components. In this case, the service supplier can create, maintain, support, etc. a computer infrastructure that performs the process steps of the invention for one or more customers. In return, the service supplier can receive payment from the customer(s) under a subscription and/or fee agreement and/or the service supplier can receive payment from the sale of advertising content to one or more third parties.

While FIG. 7 shows the computer system 90 as a particular configuration of hardware and software, any configuration of hardware and software, as would be known to a person of ordinary skill in the art, may be utilized for the purposes stated supra in conjunction with the particular computer system 90 of FIG. 7. For example, the memory devices 94 and 95 may be portions of a single memory device rather than separate memory devices.

A computer program product of the present invention comprises one or more computer readable hardware storage devices having computer readable program code stored therein, said program code containing instructions executable by one or more processors of a computer system to implement the methods of the present invention.

A computer system of the present invention comprises one or more processors, one or more memories, and one or more computer readable hardware storage devices, said one or more hardware storage devices containing program code executable by the one or more processors via the one or more memories to implement the methods of the present invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for using a shared mixture of experts (MoE) architecture to implement inference with respect to a machine learning model (MLM), said method comprising:
receiving, from N clients by a gate mechanism comprising N gates, N requests and an identification of N MoE models, respectively, wherein the N MoE models comprise N sets of experts and N gates, respectively, for each model layer, wherein N is at least 2, wherein the N sets of experts are stored in one or more graphics processing units (GPUs), wherein each expert of the N experts is a machine learning model trained to have expertise in handling specific types of tasks, wherein the N gates are each a machine learning model trained to select experts to process given requests by matching the expertise of each expert to the types of tasks specified in the given requests, wherein the N sets of experts collectively comprise at least one duplicative expert that is common to more than one set of experts of the N sets of experts, and wherein each duplicative expert has been deduplicated by being stored only once in the one or more GPUs;
selecting, by the gate mechanism from the N sets of experts, E experts to process the N requests, wherein the E experts include the at least one duplicative expert;
routing the N requests to the E experts;
executing the E experts to generate N respective responses to the N requests, wherein said executing the E experts comprises each expert of the E experts performing only specific types of tasks that each expert of the E experts has expertise in handling; and
transmitting each response of the N responses to a respective client of the N clients.

2. The method of claim 1, wherein said selecting the E experts comprises selecting K top ranked experts from each set of experts of the N sets of experts, wherein K is a positive integer of at least 2, and wherein E < K*N.

3. The method of claim 1, wherein an identity of each deduplicated expert is mapped to a merged representation that links each deduplicated expert to the requests of different clients, and wherein said routing the N request to the E experts comprises:
batching the N requests of the different clients to the deduplicated experts by routing the N requests to the E experts in parallel which avoids sequential invocation of the N gates for routing the N requests to the E experts.

4. The method of claim 1, wherein the gate mechanism comprises a single fused gate that combines the N gates’ functionalities for each model layer, wherein the fused gate selects the E experts which are a same E experts that would have been selected by the N gates individually if the N gates were not combined into the fused gate, wherein the fused gate routes the N requests to the E experts in parallel which avoids sequential invocation of the N gates for routing the N requests to the E experts, and wherein the gate mechanism includes a gate mapping for each gate of the N gates.

5. The method of claim 1, wherein said executing the E experts comprises:
batch executing, by the deduplicated experts, M requests of the N requests by executing the M requests in parallel which is facilitated by multiple streaming multiprocessors (SM's) in the one or more GPUs that comprise the deduplicated experts.

6. The method of claim 1, wherein each expert in the N sets of experts comprises multiple tensors, wherein the one or more GPUs is a plurality of GPUs, wherein one expert in the N sets of experts does not fit into any GPU of the plurality of GPUs, and wherein each expert of the one expert has been sharded to distribute the multiple tensors of the one expert across the plurality of GPUs.

7. The method of claim 1, wherein each expert in the N sets of experts comprises multiple tensors, wherein a first expert and a second expert of the E experts comprises at least one duplicative tensor that is common to the first expert and the second expert, and wherein each duplicative tensor has been deduplicated by being stored only once in the one or more GPUs.

8. A computer program product, comprising one or more computer readable hardware storage devices having computer readable program code stored therein, said program code containing instructions executable by one or more processors of a computer system to implement a method for using a shared mixture of experts (MoE) architecture to implement inference with respect to a machine learning model (MLM) that includes model layers, said method comprising:
receiving, from N clients by a gate mechanism comprising N gates, N requests and an identification of N MoE models, respectively, for each model layer, wherein the N MoE models comprise N sets of experts and N gates, respectively, wherein N is at least 2, wherein the N sets of experts are stored in one or more graphics processing units (GPUs), wherein each expert of the N experts is a machine learning model trained to have expertise in handling specific types of tasks, wherein the N gates are each a machine learning model trained to select experts to process given requests by matching the expertise of each expert to the types of tasks specified in the given requests, wherein the N sets of experts collectively comprise at least one duplicative expert that is common to more than one set of experts of the N sets of experts, and wherein each duplicative expert has been deduplicated by being stored only once in the one or more GPUs;
selecting, by the gate mechanism from the N sets of experts, E experts to process the N requests, wherein the E experts include the at least one duplicative expert;
routing the N requests to the E experts;
executing the E experts to generate N respective responses to the N requests, wherein said executing the E experts comprises each expert of the E experts performing only specific types of tasks that each expert of the E experts has expertise in handling; and
transmitting each response of the N responses to a respective client of the N clients.

9. The computer program product of claim 8, wherein said selecting the E experts comprises selecting K top ranked experts from each set of experts of the N sets of experts, wherein K is a positive integer of at least 2, and wherein E < K*N.

10. The computer program product of claim 8, wherein an identity of each deduplicated expert is mapped to a merged representation that links each deduplicated expert to the requests of different clients, and wherein said routing the N request to the E experts comprises:
batching the N requests of the different clients to the deduplicated experts by routing the N requests to the E experts in parallel which avoids sequential invocation of the N gates for routing the N requests to the E experts.

11. The computer program product of claim 8, wherein the gate mechanism comprises a single fused gate that combines the N gates’ functionalities for each model layer, wherein the fused gate selects the E experts which are a same E experts that would have been selected by the N gates individually if the N gates were not combined into the fused gate, wherein the fused gate routes the N requests to the E experts in parallel which avoids sequential invocation of the N gates for routing the N requests to the E experts, and wherein the gate mechanism includes a gate mapping for each gate of the N gates.

12. The computer program product of claim 8, wherein said executing the E experts comprises:
batch executing, by the deduplicated experts, M requests of the N requests by executing the M requests in parallel which is facilitated by multiple streaming multiprocessors (SM's) in the one or more GPUs that comprise the deduplicated experts.

13. The computer program product of claim 8, wherein each expert in the N sets of experts comprises multiple tensors, wherein the one or more GPUs is a plurality of GPUs, wherein one expert in the N sets of experts does not fit into any GPU of the plurality of GPUs, and wherein each expert of the one expert has been sharded to distribute the multiple tensors of the one expert across the plurality of GPUs.

14. The computer program product of claim 8, wherein each expert in the N sets of experts comprises multiple tensors, wherein a first expert and a second expert of the E experts comprises at least one duplicative tensor that is common to the first expert and the second expert, and wherein each duplicative tensor has been deduplicated by being stored only once in the one or more GPUs.

15. A computer system, comprising one or more processors, one or more memories, and one or more computer readable hardware storage devices, said one or more hardware storage devices containing program code executable by the one or more processors via the one or more memories to implement a method for using a shared mixture of experts (MoE) architecture to implement inference with respect to a machine learning model (MLM) that includes model layers, said method comprising:
receiving, from N clients by a gate mechanism comprising N gates, N requests and an identification of N MoE models, respectively, wherein the N MoE models comprise N sets of experts and N gates, respectively, for each model layer, wherein N is at least 2, wherein the N sets of experts are stored in one or more graphics processing units (GPUs), wherein each expert of the N experts is a machine learning model trained to have expertise in handling specific types of tasks, wherein the N gates are each a machine learning model trained to select experts to process given requests by matching the expertise of each expert to the types of tasks specified in the given requests, wherein the N sets of experts collectively comprise at least one duplicative expert that is common to more than one set of experts of the N sets of experts, and wherein each duplicative expert has been deduplicated by being stored only once in the one or more GPUs;
selecting, by the gate mechanism from the N sets of experts, E experts to process the N requests, wherein the E experts include the at least one duplicative expert;
routing the N requests to the E experts;
executing the E experts to generate N respective responses to the N requests, wherein said executing the E experts comprises each expert of the E experts performing only specific types of tasks that each expert of the E experts has expertise in handling; and
transmitting each response of the N responses to a respective client of the N clients.

16. The computer system of claim 15, wherein said selecting the E experts comprises selecting K top ranked experts from each set of experts of the N sets of experts, wherein K is a positive integer of at least 2, and wherein E < K*N.

17. The computer system of claim 15, wherein an identity of each deduplicated expert is mapped to a merged representation that links each deduplicated expert to the requests of different clients, and wherein said routing the N request to the E experts comprises:
batching the N requests of the different clients to the deduplicated experts by routing the N requests to the E experts in parallel which avoids sequential invocation of the N gates for routing the N requests to the E experts.

18. The computer system of claim 15, wherein the gate mechanism comprises a single fused gate that combines the N gates’ functionalities for each model layer, wherein the fused gate selects the E experts which are a same E experts that would have been selected by the N gates individually if the N gates were not combined into the fused gate, wherein the fused gate routes the N requests to the E experts in parallel which avoids sequential invocation of the N gates for routing the N requests to the E experts, and wherein the gate mechanism includes a gate mapping for each gate of the N gates.

19. The computer system of claim 15, wherein said executing the E experts comprises:
batch executing, by the deduplicated experts, M requests of the N requests by executing the M requests in parallel which is facilitated by multiple streaming multiprocessors (SM's) in the one or more GPUs that comprise the deduplicated experts.

20. The computer system of claim 15, wherein each expert in the N sets of experts comprises multiple tensors, wherein the one or more GPUs is a plurality of GPUs, wherein one expert in the N sets of experts does not fit into any GPU of the plurality of GPUs, and wherein each expert of the one expert has been sharded to distribute the multiple tensors of the one expert across the plurality of GPUs.
